(19) United States
(12) Patent Application Publication
(10) Pub. No.: US 2005/0007430 A1
(43) Pub. Date: Jan. 13, 2005

(54) Method and system of printheads using electrically conductive solvents

(75) Inventors: Charles William Rowe, Medford, MA (US); Peter A. Materna, Metuchen, NJ (US); Thomas George West, Lawrenceville, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Therics, Inc., Princetor, NJ (US)

(21) Appl. No.: 10/808,726

(22) Filed: Mar. 24, 2004

Related U.S. Application Data
(60) Provisional application No. 60/457,157, filed on Mar. 24, 2003.

(51) Int. Cl. B41J 2/17

(52) U.S. Cl. 347/95

(57) ABSTRACT

A composition having an electrical conductivity sufficient to enable droplets to be easily charged when printing through a continuous jet with deflection printhead. The composition may include a halogenated hydrocarbon solvent, a co-solvent that is miscible with the halogenated hydrocarbon solvent, and a conductivity enhancing substance. The halogenated hydrocarbon solvent may be chloroform, and the co-solvent may be an alcohol, such as methanol or ethanol. The conductivity enhancing substance may be a salt that dissociates upon dissolution to form ions, or may be an acid or a polymer. The conductivity enhancing substance may be chosen to be benign if left in a printed product. The conductivity enhancing substance may be chosen to be volatile so as to be able to evaporate from whatever it is printed upon, and specifically may be chosen to be a liquid at room temperature. The conductivity enhancing substance may be chosen so as to comprise only carbon, oxygen, hydrogen and nitrogen, and in particular may be an ammonium salt; elements commonly found in bodily tissue. Alternatively, the conductivity enhancing substance may be chosen so as to contain ions of metals but only of certain specific metals.

### BACKGROUND OF THE INVENTION

1. Field of the Invention

This invention relates to electrostatic charging of drops of liquid for use in printing, and more particularly, for use in three-dimensional printing.

2. Description of the Related Art

One type of printhead useful in printing including for example, three-dimensional printing, is a continuous jet with deflection (CJ-D) printhead. In such a printhead, a continuous jet of liquid issues from a small orifice and shortly thereafter breaks up into a stream of drops; individual drops may be electrically charged at the time of breakoff. The electrical charge on an individual droplet enables that droplet to be electrostatically deflected as it passes through a deflection cell; either permitting, preventing or modifying its trajectory toward whatever is being printed upon. Uncharged drops are not deflected. Such printheads are described for example, in U.S. Pat. No. 5,807,437 herein incorporated in its entirety by reference.

In order to achieve charging of droplets, the electric charge has been brought into a droplet at the time the droplet breaks off from the jet, by conduction of electricity through the liquid of the jet from which the droplet is formed. For typical dimensions and operating parameters of CJ-D printheads, it has been necessary that the liquid being dispensed have an electrical conductivity that is greater than a certain minimum value; typically this minimum value has been in the tens of micro-Siemens/cm.

For aqueous liquids, for example, it has been easy to achieve the required electrical conductivity because so many substances dissolve in water and many ionic compounds, when dissolved in water even at very small concentrations, have been capable of producing sufficient electrical conductivity. Extremely pure water, however, would not have sufficient electrical conductivity for this purpose.

Another category of liquid of interest for certain printing applications is halogenated hydrocarbon solvents such as chloroform. Halogenated hydrocarbon solvents are good solvents for certain substances, including many substances that are not water-soluble and including many substances that are of interest for medical applications. Pure chloroform, for example, has an extremely small electrical conductivity of less than 0.01 micro-Siemens/cm and is not by itself suitable for use in a CJ-D printhead. Various electrical conductivity enhancement additives for various solvents have been used in the field of electrophoresis and chromatography, but such techniques can not be carried over to the technology of printheads. For example, electrical conductivity enhancement additives such as cyclohexanone and isobutyl acetate have been used in the field of electrostatic paint spraying, but these additives have not been found useful when added directly to chloroform by themselves.

Three-dimensional printing, described for example in U.S. Pat. No. 5,204,055 and herein incorporated in its entirety by reference, is a method of producing three-dimensional objects from powder using a binder liquid to bind powder particles to each other. Three-dimensional printing has been useful for a variety of purposes but has been generally unavailable for applications that require the use of halogenated hydrocarbon solvents as the binder liquid. This has been due to a combination of the inability to charge halogenated hydrocarbon solvents for use in CJ-D printheads, and to a variety of difficulties associated with the use of halogenated hydrocarbon solvents in other types of printheads.

### BRIEF SUMMARY OF THE INVENTION

The invention includes a composition having an electrical conductivity sufficient to enable droplets to be easily charged. In this aspect of the invention, the composition may comprise a halogenated hydrocarbon solvent, and a co-solvent that is miscible with the halogenated hydrocarbon solvent, and a conductivity enhancing substance, such that the composition has a desired electrical conductivity. According to aspects of the present invention, the halogenated hydrocarbon solvent may be chloroform, and the co-solvent may be an alcohol, such as methanol or ethanol.

According to further aspects of the present invention, the conductivity enhancing substance may be a salt that dissociates upon dissolution to form ions, or may be an acid or a polymer. The conductivity enhancing substance may be chosen to be benign if left in a printed product, for example, if the printed product is an implant. Alternatively, the conductivity enhancing substance may be chosen to be volatile so as to be able to evaporate from whatever it is printed upon, and specifically may be chosen to be a liquid at room temperature. According to further aspects of the invention, the conductivity enhancing substance may be chosen so as to comprise only carbon, oxygen, hydrogen and nitrogen, and in particular may be an ammonium salt; elements commonly found in bodily tissue. Alternatively, the conductivity enhancing substance may be chosen so as to contain ions of metals but only of certain specific metals.

The invention also comprises a printhead using the composition, and a method of performing three-dimensional printing using the composition and printhead, and articles manufactured by that method. The invention also includes compositions comprising hydrocarbon liquids with additives similar to those described in connection with halogenated hydrocarbon solvents.

### BRIEF DESCRIPTION OF THE DRAWINGS

The invention is further illustrated in the following Figures:

FIG. 1 illustrates a Continuous Jet with Deflection printhead, which may use the composition of the present invention in accordance with principles of the present invention.

FIG. 2 illustrates a three-dimensional printing apparatus in accordance with the prior art; the apparatus may use the printhead of FIG. 1 and use the composition of the present invention.

FIG. 3 illustrates the electrical conductivity of a chloroform-based composition of the present invention, as a function of the concentration of additives, in accordance with principles of the present invention.

### DETAILED DESCRIPTION OF THE INVENTION

Composition Having Desired Electrical Conductivity

One aspect of the invention is a composition having a desired electrical conductivity. Solvents of interest for ordinary printing and for three-dimensional printing include halogenated hydrocarbon solvents such as chloroform (CHCl₃). The composition of the present invention includes a halogenated hydrocarbon solvent, which may be chloroform. In addition, the composition includes a co-solvent that is miscible with the halogenated hydrocarbon solvent.

The co-solvent may be chosen to have a dielectric constant greater than approximately 20, or greater than approximately 10. It is believed, although it is not wished to be restricted to this explanation, that a useful property of the co-solvent is for the co-solvent to have a relatively large dielectric constant. Such a value of the dielectric constant tends to be associated with a molecular geometry that is polar or asymmetric. A relatively large dielectric constant of the co-solvent also tends to be associated with the ability of the co-solvent to cause substances to dissociate when those substances are dissolved in the co-solvent. Dissociation in turn is helpful for creating electrical conductivity in a solution. The co-solvent may be an alcohol that is miscible with the halogenated hydrocarbon solvent and, in particular, the co-solvent may be methanol or ethanol.

Methanol and ethanol are miscible with chloroform in all proportions, and it is believed that these and other relatively low molecular weight alcohols also have good miscibility with halogenated hydrocarbon solvents in general. In general, molecules of alcohol comprise a hydrocarbon portion that resembles pure hydrocarbons and an OH portion that resembles water. Higher molecular weight alcohols are more dominated by the hydrocarbon portion of the molecule and are more miscible with hydrocarbons than they are with water. Low molecular weight alcohols are completely miscible with water as well as being completely miscible with hydrocarbons.

The lowest molecular weight alcohols (such as those having only several carbon atoms) also are somewhat polar molecules having a somewhat large dielectric constant. Among the alcohols, methanol has a relatively large dielectric constant of 33, and ethanol has a dielectric constant of 24.3. Methanol and ethanol also have good ability to dissolve various possible conductivity enhancing substances. There are also other possible co-solvents, including other relatively low molecular weight alcohols; acetone, which has a dielectric constant of 20.7; and formamide, which has a dielectric constant of 109. For reference, the dielectric constant of water, which is not miscible with chloroform, is 80.

In addition to the halogenated hydrocarbon solvent and the co-solvent, the composition may further comprise a conductivity enhancing substance that is at least slightly soluble either in the co-solvent or in the halogenated hydrocarbon solvent, or both, and which enhances electrical conductivity such that the composition comprising the halogenated hydrocarbon solvent, the co-solvent and the conductivity enhancing substance has a desired electrical conductivity.

Specifically, the conductivity enhancing substance may be soluble in the co-solvent. It may be that the conductivity enhancing substance is not very soluble in the halogenated hydrocarbon solvent. It is also possible that the conductivity enhancing substance is soluble to at least some extent in the halogenated hydrocarbon solvent, but the combination of only the halogenated hydrocarbon solvent and the conductivity enhancing substance does not result in a useful electrical conductivity, whereas the combination of the halogenated hydrocarbon solvent and the co-solvent and the conductivity enhancing substance does result in a useful electrical conductivity. The conductivity enhancing substance may be chosen so that its molecule has at least one ionic bond.

One possible category for the conductivity enhancing substance is that the conductivity enhancing substance may be a salt. A salt may comprise an anion and a cation ionically bonded to each other. The conductivity enhancing substance may be chosen to be a salt, as a general category, because salts have at least some ability to dissociate into ions when the salt is in solution in a liquid.

As far as the anion in the salt, the conductivity enhancing substance may be a salt in which the anion is an organic radical, i.e., is formed from an organic acid. An organic acid is an acid that comprises only carbon and hydrogen and oxygen. Use of an organic radical for the anion may be useful for making the conductivity enhancing substance biocompatible for medical applications.

The conductivity enhancing substance may be a salt in which the anion is a lipophilic chain. A lipophilic chain in a salt, because of its structural and chemical similarity to possible co-solvents such as alcohols and to the halogenated hydrocarbon solvents themselves, is believed to promote the ability of the salt to dissolve in those liquids, because of the affinity of the lipophilic chain in the salt for the corresponding chemical structure in those liquids. Upon such dissolution the lipophilic chain dissociates from the cation, and the presence of the resulting ions increases the electrical conductivity of the composition.

Salts having anions which are organic and, in many cases, lipophilic, include lactate, acetate, propionate, formate, salicylate, stearate, malate, laurate, oxalate, oleate, citrate, benzoate, succinate, myristate and tartarate. This category would include any of the lactates that are described in Examples herein.

As far as the cation in the salt, the conductivity enhancing substance may be a salt in which the cation is a metal. Cations of sodium, potassium and calcium are already present in the human body because they are contained in substances that naturally occur in the human body. Magnesium may also be a useful and biologically acceptable cation in the composition of the present invention. Sodium L-lactate is an example of a substance having a sodium atom as a cation. Even sodium chloride, another example of an ionic compound, is slightly soluble in alcohol.

It is also possible that the conductivity enhancing substance may be a salt in which the cation is not a metal but rather is a metal-free radical such as an organic radical. In particular, such a metal-free cation may be the ammonium radical. In an ammonium salt the ammonium radical behaves similarly to a metallic ion, in that when the salt goes into solution the salt can dissociate into ions. It has been found in the course of this invention that ammonium salts can produce electrical conductivities that are quite adequate for use in CJ-D printheads, possibly because of the degree of dissociation exhibited by the ammonium salt when it is in solution in a co-solvent such as methanol.

If a salt includes an ammonium radical as the cation and an organic radical as the anion, then that salt is a conductivity enhancing substance that contains (at most) only hydrogen and carbon and oxygen and nitrogen, all of which are present in various other biological substances.

It may be that the ammonium radical is acceptable for biomedical applications because the only constituents of the ammonium radical are nitrogen and hydrogen, which are also present in various biological substances. It may also be true that ammonium salts are more likely to be evaporable at a relatively low temperature than are metallic salts, and thus are more likely to be removable from an article being manufactured so as not to leave behind solid residue. This may be associated with their relatively low molecular weight. Examples of suitable ammonium salts include ammonium lactate and ammonium acetate.

Salts are not the only possible category of conductivity enhancing substances. Acids in liquid solution are also known to exhibit some degree of dissociation. The conductivity enhancing substance may be an acid that is capable of dissolving in the co-solvent. The acid may be an organic acid. Acetic acid is an example of an organic acid, which is liquid at room temperature and hence able to evaporate, and which is miscible with alcohols, and which can result in at least a modest electrical conductivity for a composition comprising a halogenated hydrocarbon solvent and a co-solvent and the acid.

Still another category of conductivity enhancing substance is that the conductivity enhancing substance may be a polymer. Methacrylate polymers can dissolve and dissociate in chloroform-alcohol mixtures to increase the electrical conductivity of those compositions to a value suitable for present purposes. These polymers contain dissociable side groups on the main polymer chain.

There are also forms of polymers that are acids. PLGA (poly lactic co-glycolic acid) can dissolve and dissociate in chloroform-alcohol mixtures to increase the electrical conductivity of those compositions to a value suitable for present purposes. Both methacrylate polymers and PLGA are typically used in pharmaceutical dosage forms and are non-toxic at the levels that would be used in the present invention. Poly acrylic acid and poly methacrylic acid are additional examples of polymers which are acids and which have dissociable side groups.

There are also forms of polymers that are salts of those acids. Examples of such polymers are polymers with a metal cation such as a sodium salt of polyacrylic acid, a sodium salt of poly methacrylic acid, carboxymethylcellulose sodium, etc., and in general, any salt formed by a metal cation with the acid form of a polymer.

In any of these categories of conductivity enhancing substances (salts, acids, polymers), the conductivity enhancing substance may be chosen to have any of various properties as far as melting and boiling behavior. The conductivity enhancing substance may be solid at room temperature. One possibility is that the conductivity enhancing substance may be solid at room temperature and up to and beyond the maximum allowable temperature of the article being printed upon or manufactured. Many salts, such as many salts in which the cation is a metal, have such properties, which mean that a small quantity of the salt might have to be deposited or left behind in a printed object after evaporation of the halogenated hydrocarbon solvent and the co-solvent. One such salt is sodium L-lactate, which is described in an Example herein. It is believed that, even in many biomedical applications, a small amount of sodium L-lactate would be acceptable in a finished product because of the similarity of sodium L-lactate to substances known to occur in the body and because of the small quantity of sodium L-lactate involved.

On the other hand, it may be that for some applications it is undesirable for the final printed or manufactured article to contain any solid conductivity enhancing substance at all. Accordingly, the conductivity-enhancing substance may be a substance that, at a temperature less than the maximum allowable temperature for an article being manufactured, is suitable to be substantially removed from the article by evaporation or sublimation. The ability of a substance to evaporate or sublimate is described by the vapor pressure of the substance, which is usually a strong function of temperature, and by the boiling and/or melting points of the substance. Not only do liquids have a vapor pressure, but also solids.

Removal of the conductivity enhancing substance is possible if the conductivity enhancing substance is a liquid at room temperature, or if the conductivity enhancing substance is a solid at room temperature but has a melting point below the maximum allowable temperature of the article being printed upon or manufactured, or even if the conductivity enhancing substance does not even have a melting point below the maximum allowable temperature but merely has a sufficient vapor pressure to allow it to substantially evaporate at some temperature below the maximum allowable temperature, or if it sublimes at a temperature below the maximum allowable temperature.

In those instances in which the conductivity enhancing substance does melt below the maximum allowable temperature of the article being printed upon or manufactured, the conductivity enhancing substance may be chosen either so that it has a boiling point below the maximum allowable temperature of the article being printed upon or manufactured, or so that it does not have a boiling point below the maximum allowable temperature.

An example of a salt that is liquid at room temperature and boils below a likely maximum allowable temperature is ammonium lactate. An example of a salt which is solid at room temperature but which can sublimate at or somewhat above room temperature is ammonium acetate, and also ammonium propionate, and ammonium carbamate.

It is also possible that the conductivity enhancing substance may be chosen to be a substance that decomposes at an appropriate temperature, such as a temperature above room temperature but below the maximum allowable temperature of an article being manufactured. Some ammonium salts decompose at temperatures that are likely to be within the temperature range of typical articles manufactured by processes described herein. Ammonium carbonate is such a decomposable salt.

It is also possible that there might be still further need to assist in the complete removal of some substance, beyond what occurs through processes already described such as evaporation, or to remove a substance that does not leave to any significant extent by the processes already described. In any of these categories of conductivity enhancing substances (salts, acids, polymers), the conductivity enhancing substance may be chosen so that it is suitable to dissolve in and be removed by a supercritical fluid or pressurized liquid, which may be carbon dioxide. Details and other possible fluids are further described elsewhere herein.

The conductivity enhancing substance may also be chosen to be water soluble for possible removal by dissolution in water, or may be chosen to be soluble in alcohol or some other organic solvent for possible removal by dissolution in such a solvent.

In many usages of halogenated hydrocarbon solvents such as chloroform, the reason for interest in using the halogenated hydrocarbon solvent is because of the ability of the halogenated hydrocarbon solvent to dissolve substances of interest that cannot be dissolved by a more conventional solvent such as water or possibly even alcohols. Such substances of interest to be dissolved may include polymers or Active Pharmaceutical Ingredients. Despite the presence of the co-solvent and the conductivity enhancing substance in the composition of the present invention, the described composition still retains substantial ability to dissolve the substances of interest.

In some applications, at the time the described composition is being electrically charged or dispensed through a printhead, it is possible that the composition may comprise such substances of interest dissolved in the composition, in addition to what has already been enumerated as being contained in the composition. For example, the composition may contain, at the time it is being electrically charged or dispensed through a printhead, dissolved Active Pharmaceutical Ingredients and/or dissolved polymers.

Printhead Using the Composition

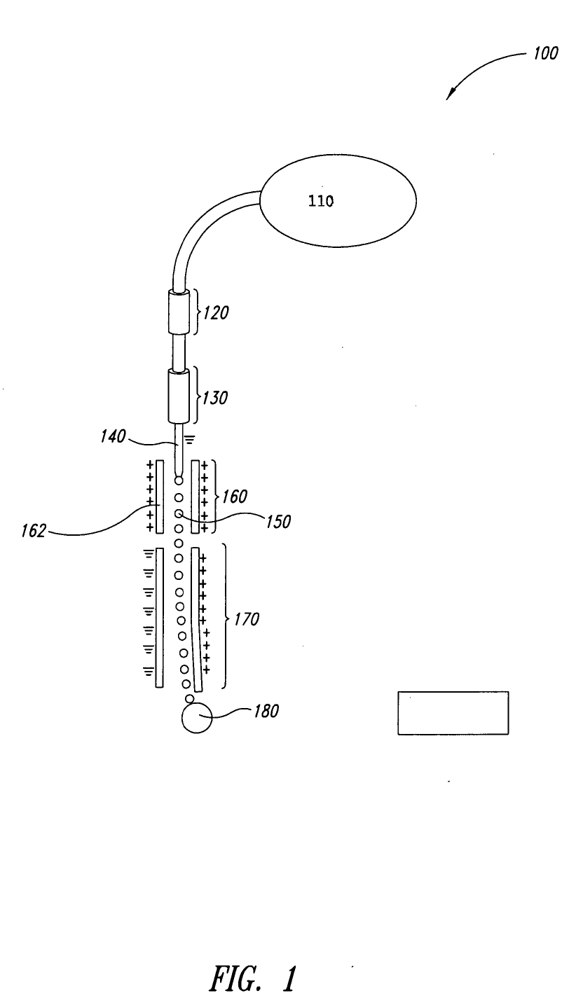

Another aspect of the present invention is a printhead comprising the described compositions. FIG. 1 illustrates a Continuous Jet with Deflection printhead. Such a printhead may comprise a source 100 of liquid 110, which may be pressurized. The liquid 110 may be any of the compositions described herein. The source 100 supplies liquid 110 to an orifice 130 that defines a jet 140. Upstream of orifice 130 the liquid 110 may pass through an excitation means 120, for example, a piezoelectric device, which stimulates the flowing liquid so that the jet 140 breaks up into individual droplets 150 sooner and more predictably than would occur without such stimulation.

In proximity to jet 140, near the point of breakoff of droplets 150, may be a charging cell 160 which is electrically powered suitably to cause an electric charge in the liquid which is about to break off into an individual droplet, in response to the electrical conditions of the charging cell 160. Creation of an electrostatic charge on a droplet can be done by exposing the droplet to a precisely timed electric field in the charging cell 160 slightly prior to and at the time when the droplet breaks off from the continuous jet.

The charging cell may comprise a pair of parallel plates 162 on both sides of the jet 140, or a surrounding hollow structure surrounding the jet 140, with either the plates 162 or the surrounding hollow structure being disposed to act as one member of a capacitor while the jet 140 acts as the other member.

Creation of electrostatic charge on a droplet 150 may involve electrical continuity and conductance between the forming droplet and a place further back along the fluid path, which may be an electrical grounding point. The electric field in the charging cell may draw charge into the forming droplet through an electric circuit that includes an electrical path back along the fluid path to a point of electrical grounding or contact to the fluid. After the droplet 150 breaks off from the jet 140, the droplet 150 may, for the remainder of its trajectory, retain the charge it had at the time it broke off.

Downstream of the charging cell 160, and also in close proximity to the path of the traveling droplets 150, may be a deflection cell 170, which may be electrically powered suitably to create an electric field which can deflect charged droplets 150 by interacting with the charge carried on those droplets. Deflection cell 170 may create an electric field that is a steady-state electric field.

Droplets 150 which are not intended to pass through deflection cell 170 to the article being manufactured may be charged and deflected so as to be caught by a catcher device 180 which may be located downstream of deflection cell 170 in the path of travel of deflected droplets. Uncharged droplets may pass through deflection cell 170 without being deflected and may proceed to the article being printed upon or manufactured. It is also possible for droplets to be given a charge to an extent which results in them being somewhat deflected as they pass through deflection cell 170, but not being deflected so far as to be caught by catcher 180. Such proportional deflection may be used to steer drops for detailed adjustment of their position or trajectory.

Dimensions, operating voltages and other operating parameters of the printhead may be chosen so as to co-operate suitably with the properties of the liquid composition of the present invention, including its electrical conductivity, to produce the desired amount of charging of droplets and the desired amount of deflection of droplets at desired conditions.

Although a continuous jet with deflection printhead has just been described, it is also possible that there can be a printhead that issues its drops by something other than a continuous jet and which still involves electrostatic charging of the drops and deflection of the drops. The composition of the present invention could also be used equally well in such a printhead.

Method of Manufacturing Using the Composition

Another aspect of the present invention is a method of printing or three-dimensional printing using the composition of the present invention such as in the described printhead.

As far as preparation of the composition of the present invention which would be used in the described printhead or the described method, it is possible to prepare the composition by first dissolving the conductivity enhancing substance in the co-solvent, since many of the conductivity enhancing substances disclosed herein are more soluble in the co-solvent than in the halogenated hydrocarbon solvent. Then, the solution comprising the conductivity enhancing substance and the co-solvent could be combined with the halogenated hydrocarbon solvent.

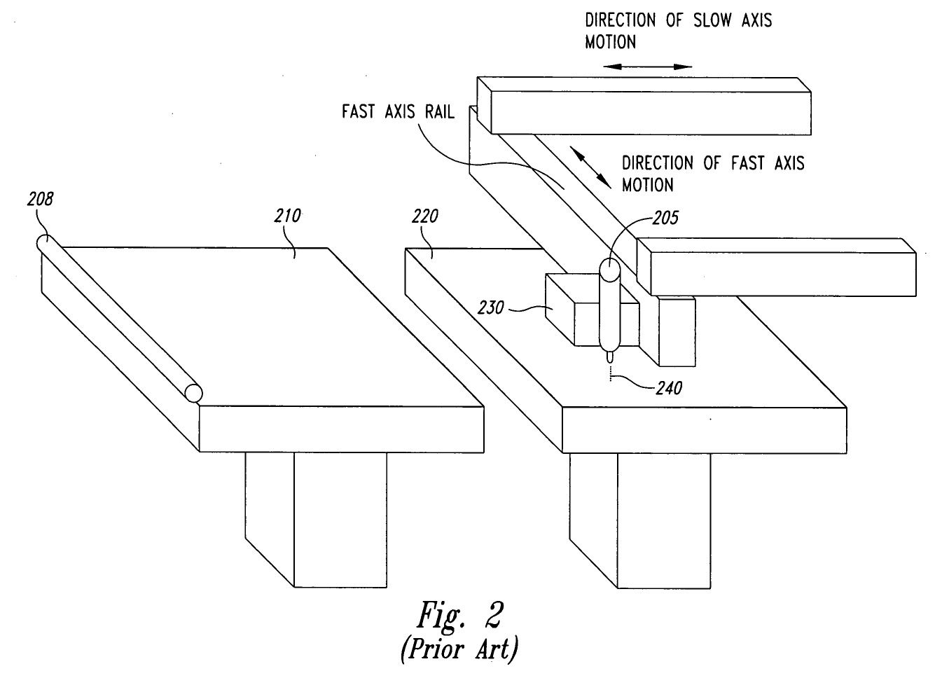

The basic process of three-dimensional printing is illustrated in FIG. 2. In three-dimensional printing, successive layers of powder 200 are deposited on a substrate or build bed 220. The powder may be deposited by being spread with a roller 208 from a feed bed 210 across the top of the substrate or prior layer, although it is also possible to deposit powders of fine material by depositing slurry or by other means. After each layer of powder has been deposited on the build bed 220, a printhead 230 may dispense binder liquid 240 or some other fluid onto preselected areas of the powder to form a layer of the final product.

The printhead 230 may be a continuous jet with deflection printhead dispensing the composition of the present invention, or it may in general be any type of printhead that involves electrostatic charging of droplets, and may dispense the composition of the present invention. The binder liquid 240 that is dispensed onto the powder 200 may cause portions of each layer to adhere to themselves and to adjacent earlier-deposited layers.

One way to achieve binding is through dissolution of powder by the binder liquid followed by resolidification when the binder liquid evaporates. Another way is through the deposition of a binder substance such as an adhesive which is initially dissolved in or mixed with the binder liquid 240 and which is left behind on the powder 200 when the volatile component(s) of the binder liquid 240 evaporate. Yet another way is for a binder substance to be a portion of the powder 200 and to dissolve in the binder liquid 200 and later resolidify so as to bind powder particles together.

The printhead 230 may be moved by a motion control system 250 which may be any of various known types. The process may be repeated for successive layers and may have different geometric instructions at each layer. Through this sequential process a three-dimensional product is ultimately formed.

It is possible, although not necessary, to apply heat between layers of powder deposition in order to accelerate the evaporation of volatile substances. At the completion of 3DP, the printed article may be separated from unbound powder and possibly small amounts of unbound powder may be further removed by a de-dusting operation. Either before or after powder removal and de-dusting, it is possible to heat the entire article to further cause evaporation of volatile substances from the binder liquid. In any application of heat, the temperature may be chosen to be a temperature which is less than the maximum allowable temperature of the article being printed, and which is suitable to accelerate the evaporation of any or all of the halogenated hydrocarbon, the co-solvent and the conductivity enhancing substance.

The time and temperature may be selected to substantially remove any solvent or other volatile substance remaining in the article, or to remove them only to a desired extent. The time and temperature may be selected to remove (either substantially or to a desired extent) any conductivity enhancing substance, if it is volatile, remaining in the article. In the case of three dimensional printing, heating may be performed after the entire article has been printed, which may be either before or after the article has been harvested from its powder bed and de-dusted, or at least some heating may be performed after printing of individual layers before the depositing of powder for a subsequent layer (known as inter-layer drying), or both.

It is further possible that substances such as the conductivity enhancing substance, as well as the halogenated hydrocarbon solvent and the co-solvent, may be removed from the article by exposing the article to a reduced partial pressure of the vapor of the substance in question. Reduced partial pressure or concentration of vapor near the article increases the driving force for evaporation of the substance, whether that substance is liquid or solid. One such method is by exposing the article to a vacuum or reduced ambient total pressure, such as in the process of freeze-drying or lyophilization. Reduced ambient total pressure results a reduced partial pressure or concentration of vapor near the article, which increases the driving force for evaporation.

It is also possible to achieve a similar effect by a continuous flow of a sweep gas, even at ambient total pressure, as long as the incoming sweep gas is completely or nearly free of the vapor, because the sweep gas would continuously remove vapor and thereby maintain a low value of the local concentration (partial pressure) of vapor near the article, which would encourage evaporation.

Either of these methods of maintaining a reduced partial pressure of vapor can be performed either at elevated temperature or at room temperature, or in general at any temperature. The criterion for achieving sufficient evaporation would in general be a combination of time, temperature, and vacuum or vapor concentration that is maintained at the article. The use of reduced partial pressure of vapor (either by vacuum or by a sweep gas) to accelerate evaporation can reduce the need for using elevated temperature to accelerate evaporation, which in turn may affect how much of a certain substance leaves the article by evaporating as contrasted to decomposing. Exposure to reduced partial pressure can be performed either simultaneous with heating or apart from heating, in any order, or without heating. Evaporated substances may be recaptured by a cold trap, adsorption onto activated charcoal, etc.

It is further possible that after the manufacturing steps described so far, substance(s) may be removed from the article by immersing the article in or exposing the article to a supercritical fluid or a pressurized liquid which is capable of dissolving the substance(s). Supercritical fluids or liquids pressurized to elevated pressures, such as approaching the supercritical state, are known to have exceptional abilities to dissolve certain substances, including for example oils, caffeine and contaminants of various kinds. The supercritical fluid or liquid may be carbon dioxide, as is known for such extractions. Such an operation may be performed, as is known, for the purpose of removing from the article residual chloroform which may have penetrated and been absorbed sufficiently deeply within powder particles that it did not completely evaporate in a reasonable time by ordinary evaporative processes.

Chloroform is miscible with liquid carbon dioxide and supercritical carbon dioxide and therefore is removable by carbon dioxide processing. It is further possible that at the same time that the liquid carbon dioxide or supercritical carbon dioxide is removing residual chloroform, the liquid carbon dioxide or supercritical carbon dioxide may also remove at least some of the conductivity enhancing substance which may remain in the manufactured article, and also any co-solvent which may remain in the manufactured article. It is further possible that the supercritical fluid or liquid may be carbon dioxide containing a small amount of an extraction co-solvent substance, which may be methanol or acetone or similar substance, which is known within the field of supercritical fluid extraction to improve the ability of carbon dioxide at elevated pressure to dissolve and extract substances whose molecular nature is polar.

It is further possible that the supercritical fluid or liquid may be or may comprise any of various alternative similar substances known in the field of supercritical fluid extraction, including nitrous oxide, sulfur hexafluoride, various relatively low molecular weight hydrocarbons (ethane, ethylene, propane, propylene) and various halogenated hydrocarbons (trifluoromethane, chlorotrifluoromethane, 1,1,1,2-tetrafluoroethane, difluoromethane, pentafluoroethane).

Such substances may be chosen so that they are gaseous at room temperature but, at appropriate pressure, either reach supercritical conditions or at least liquefy at a temperature less than the maximum allowable temperature of the article. Some of mentioned halogenated hydrocarbons liquefy at room temperature at lower (more convenient) pressures than does carbon dioxide.

It is also possible that the conductivity enhancing substance may be soluble in water and may be removed from the article at an appropriate stage of manufacturing by exposing the article to water, or may be soluble in alcohol or some other organic solvent and may be removed by exposing the article to such solvent.

Article Manufactured Using the Method or Composition

Another aspect of the invention is an article manufactured using a printhead that comprises the described composition or using the described method. Such an article may be or may include a medical device, including but not limited to pharmaceutical dosage forms, bone augmentation devices, tissue scaffolds, combinations of the above and other types of medical devices. Such an article may comprise polymers and/or Active Pharmaceutical Ingredients that are substantially insoluble in both water and alcohols. In some embodiments of the invention, such an article may be substantially free of any conductivity enhancing substance in other embodiments, the article may contain small amounts of a conductivity enhancing substance that is benign for medical applications.

The invention is further described but is in no way limited by the following non-limiting Examples.

### EXAMPLE 1

A composition of the present invention has been created using sodium lactate in the form of the sodium L-lactate isomer. The chemical composition of sodium L-lactate is NaC₃H₅O₃. The L-lactate isomer of this compound is believed to be more acceptable and more easily metabolized by the body than the other isomer.

Sodium L-lactate is very slightly soluble in pure chloroform, but a solution containing only sodium L-lactate and chloroform does not have appreciable electrical conductivity. Sodium L-lactate is also somewhat soluble in methanol and ethanol, and solutions of sodium L-lactate in methanol or ethanol do have appreciable electrical conductivity. In creating the composition, the sodium L-lactate was first dissolved in the alcohol because it is easier to dissolve sodium L-lactate in alcohol, and then the resulting solution was combined with an appropriate amount of chloroform. The following final composition was prepared:

| | |
|---|---|
| Chloroform (CHCl₃) | 90% by weight |
| Methanol (CH₃OH) | 9.9% by weight |
| Sodium L-lactate (NaC₃H₅O₃) | 0.1% by weight |

This composition has an electrical conductivity greater than 20 micro-Siemens/cm and has been used successfully in a CJ-D printhead.

Another composition that has been prepared is

| | |
|---|---|
| Chloroform (CHCl₃) | 80% by weight |
| Ethanol (C₂H₅OH) | 19.9% by weight |
| Sodium L-lactate (NaC₃H₅O₃) | 0.1% by weight |

This composition also has an electrical conductivity greater than 20 micro-Siemens/cm and also has been used successfully in a CJ-D printhead.

Another composition that has been prepared and has been used successfully in a different CJ-D printhead is

| | |
|---|---|
| Chloroform (CHCl₃) | 77.82% by weight |
| Methanol (CH₃OH) | 22.15% by weight |
| Sodium L-lactate (NaC₃H₅O₃) | 0.022% by weight |

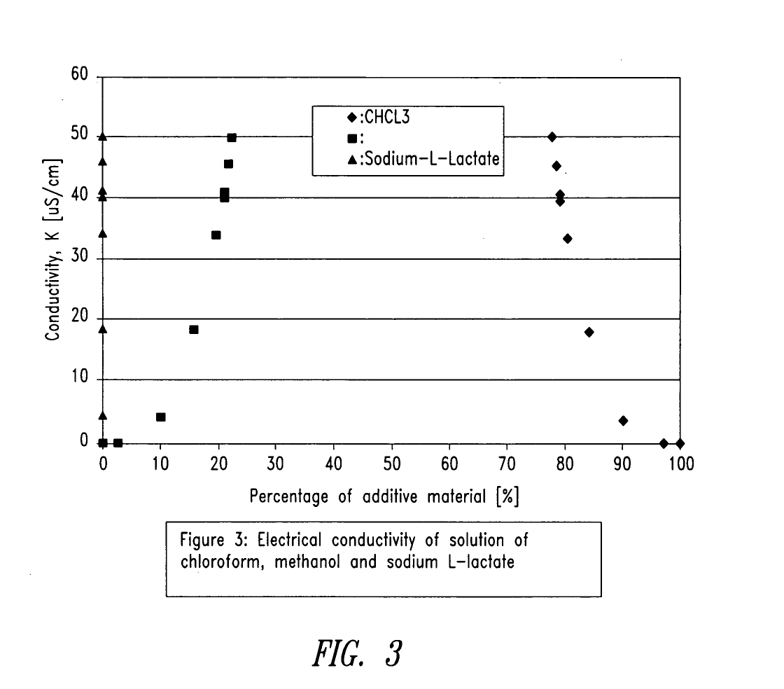

This composition was prepared by mixing sodium-L-Lactate with methanol in the ratio 100.021 g of methanol to 0.102 g of sodium-L-Lactate to form a total solution of 100.123 g (methanol: 99.9% Wt, sodium L-lactate 0.1% Wt). Then, amounts of this solution were gradually added to 240.622 g of chloroform, with the electrical conductivity being measured at each addition, until there was achieved an electrical conductivity greater than 50 micro-Siemens/cm, which was the desired electrical conductivity for this particular printhead. (50.9 PS/Cm was the exact electrical conductivity for the composition listed above.) The electrical conductivity of the family of compositions comprising chloroform, methanol and sodium L-lactate is shown in more detail in FIG. 3 as a function of composition. The electrical conductivity is shown mainly as a function of the methanol-chloroform proportion, because in all cases the concentration of sodium L-lactate was too small to be easily readable on such a graph. All measurements were taken at room temperature, such as between 20 and 25 C. This shows that if the electrical conductivity of the composition is desired to be at least approximately 50 micro-Siemens/cm, then the methanol content should be at least approximately 20% by weight. At approximately that composition, the electrical conductivity increases rapidly with increasing methanol content.

The characteristic of sodium L-lactate that increases the conductivity of the composition to allow charging is believed to be the ability of sodium L-lactate to dissociate into ions when it is dissolved in a liquid. Sodium L-lactate comprises a metallic ion and a lipophilic chain. The lipophilic chain helps sodium L-lactate to dissolve in organic liquids such as alcohols and chloroform because of the similarity of the lipophilic chain to the structure of alcohols and chloroform. In solution, the lipophilic chain dissociates from the metallic ion because of the high affinity of the lipophilic chain for organic solvents. In the case of sodium L-lactate, the lipophilic chain is a de-protonated lactic acid molecule and the metal ion is sodium.

Sodium L-lactate may be a suitable substance for biological applications in that the amount of sodium L-lactate which would be used for conductivity enhancement and would be left behind in a manufactured article is quite small, and various substances involving lactic acid or lactate compounds either occur naturally in the body or are in known biomedical use, and sodium compounds also occur naturally in the body. The other isomer of sodium lactate should also be considered to be a possible conductivity enhancing substance.

### EXAMPLE 2

A set of measurements similar to those of Example 1 was also taken with ammonium lactate as the conductivity enhancing substance. The chemical composition of ammonium lactate is NH₄C₃H₅O₃.

Ammonium lactate (available from PURAC America, Lincolnshire, Ill.) is a liquid at room temperature and has a reported boiling point of 101.6 F (38.7 C). Ammonium lactate is miscible with methanol over a wide range of proportions. A solution was prepared by combining methanol and ammonium lactate in the proportion of approximately 1 part ammonium lactate to 4 parts methanol (by volume).

This solution had an electrical conductivity of about 15 milli-Siemens/cm, which is several orders of magnitude larger than the desired electrical conductivity of the final composition. The electrical conductivity of this solution decreased slightly with increasing methanol fraction. Then, one part of this solution was combined with approximately 5 parts of chloroform. The resulting solution had an electrical conductivity of approximately 50 micro-Siemens/cm, which was the desired value. The proportions of the various substances are not critical.

At around the indicated composition, the electrical conductivity increased rapidly with further addition of the ammonium lactate and methanol solution to chloroform. Ethanol could be substituted for methanol, with some change in the proportions needed to achieve any particular electrical conductivity. Ammonium lactate has a property of not having much odor, in contrast to some of the acetate compounds and organic solvents discussed herein.

### EXAMPLE 3

A set of measurements similar to those of Example 1 was also taken for ammonium acetate. The chemical composition of ammonium acetate is NH₄C₂H₃O₂. Ammonium acetate is a solid at room temperature but it has a sufficient vapor pressure to evaporate at or slightly above room temperature. Ammonium acetate is soluble in methanol. A solution was prepared comprising:

| | |
|---|---|
| Ammonium acetate (NH₄C₂H₃O₂) | 0.027 g |
| Methanol (CH₃OH) | 9 ml |

which is a weight concentration of about 0.003 by weight ammonium acetate, 0.997 by weight methanol. This solution had an electrical conductivity of about 1.7 milli-Siemens/cm. A composition comprising 2.4 milliliters of the above solution and 6 milliliters chloroform had an electrical conductivity of about 50 micro-Siemens/cm.

### EXAMPLE 4

A set of measurements similar to those of Example 1 was taken for the family comprising chloroform, methanol and acetic acid. The chemical composition of acetic acid is CH₃COOH, and it was used in glacial form. It was found that a solution of one part acetic acid and three parts methanol had an electrical conductivity of 9 micro-Siemens/cm. Similarly, a solution of about 20% acetic acid, 80% methanol had an electrical conductivity of about 6 micro-Siemens/cm. A composition comprising approximately half the latter solution and half chloroform had an electrical conductivity of about 4 micro-Siemens/cm. This conductivity was not as large as in the Examples using salts, and might not be adequate for all purposes, but might be adequate for some purposes.

### EXAMPLE 5

Still other substances are also possible conductivity enhancing substances. Variations on the structure of sodium L-lactate will also provide dissociation and conductivity. For example, potassium L-lactate would also perform the same function. Both are salts of an organic acid. Other materials that have been shown to provide suitable conductivity in chloroform-alcohol mixtures are sodium stearate, sodium tetradecyl sulfate, and sodium lauryl sulfate. All of these additives also possess the characteristic of being materials that are relatively benign and acceptable for at least some medical purposes.

### EXAMPLE 6

The present invention need not be restricted to halogenated hydrocarbon solvents. The invention could be applied as well to hydrocarbon liquids such as light oils in situations where it is desired to convey electric charge into drops of those liquids. In such a situation, the composition of the present invention would comprise a hydrocarbon liquid, and a co-solvent such as an alcohol, and a conductivity enhancing substance as already described. The lower molecular weight alcohols are possible co-solvents because such alcohols have good miscibility with hydrocarbon liquids just as they do with halogenated hydrocarbons solvents such as chloroform. The conductivity enhancing substance could be as described elsewhere herein, and could in particular be ammonium lactate.

### EXAMPLE 7

The composition of the present invention may be applied as well in other applications involving charged droplets, even if the apparatus might not be described as a printhead. In such an application the liquid could be a halogenated hydrocarbon solvent, but it does not have to be; for example, it might be a hydrocarbon liquid as described elsewhere herein.

Such an application may comprise apparatus and methods for generating a spray of droplets without necessarily including control of droplet trajectory as is done in a printhead. The charge can be imparted to the droplets by the spraying apparatus such as walls of the fluid conduits, the nozzle, etc. Such an application may comprise a situation in which droplets are generated comprising an electric charge and then the droplets are electrostatically attracted to an object. This can be done for electrostatic spray painting, in which electrostatic charge on paint droplets may be used to cause the paint droplets to be attracted to the object being painted. For such purposes, just as in printheads, it is necessary for the liquid to have a certain electrical conductivity in order for charge to be imparted to the droplets.

Oil-based paints would comprise a substantial fraction of hydrocarbon liquid. It is possible that an oil-based paint can be made electrically conductive using an aspect of the present invention. The paint can comprise a hydrocarbon liquid and a co-solvent such as an alcohol (for example ethanol or methanol) and a conductivity enhancing substance (for example, ammonium lactate, which is itself a liquid). It is possible that the co-solvent and the conductivity enhancing substance of the present invention may be more benign or environmentally acceptable substances than the organic compounds currently used to make paint conductive for electrostatic paint spraying. A solution of alcohol and ammonium lactate by itself has an electrical conductivity which is orders of magnitude larger than the conductivity of the currently used single-substance evaporable paint additives such as cyclohexanone and isobutyl acetate, which are currently used in electrostatic paint spraying.

### EXAMPLE 8

The present invention could also be used to increase the electrical conductivity of hydrocarbon liquids for the purpose of preventing buildup of electric charge in situations where buildup of charge is not desired (as opposed to enabling electric charge to be imparted to droplets as described in previous Examples herein). Electrostatic discharge is a known hazard associated with the handling of petroleum products in bulk quantities.

Explosions caused by static electricity which has accumulated in hydrocarbon liquids have resulted in loss of life and the sinking of ships. Static electricity in hydrocarbon liquids can be generated when hydrocarbon liquids move in contact with other materials, such as when hydrocarbon liquid is being moved through pipes, mixed, poured, pumped, filtered, bubbled or otherwise agitated, or exposed to water during tank cleaning. Because of the relatively small electrical conductivity of hydrocarbon liquids, static electric charge generated frictionally can accumulate in the liquid. Under certain conditions, static electricity may subsequently cause sparking in a flammable vapor-air mixture, and ignition. Any conductivity enhancement of hydrocarbon liquids could encourage the more rapid dissipation of static electricity and could be a safety improvement.

A criterion for distinguishing between hydrocarbon liquids that will dangerously accumulate static charge and hydrocarbon liquids that will safely dissipate charge is considered to be an electrical conductivity of 50 pico-Siemens/m. In accordance with the present invention, the electrical conductivity of a hydrocarbon liquid can be increased by adding to the hydrocarbon liquid a co-solvent and a conductivity enhancing substance, in quantities sufficient to achieve an electrical conductivity suitable to reduce the risk of static electricity discharge. The composition may be selected so as to contain substances all of which are liquid at room temperature.

The co-solvent may be an alcohol such as ethanol or methanol (which are themselves useful as fuels and which are substantially miscible with typical hydrocarbon liquids). The conductivity enhancing substance may be ammonium lactate (which is a natural fermentation product and relatively inexpensive, and the fact that it is a liquid at room temperature means it will not cause problems of being deposited as a solid residue in equipment which handles the petroleum). The proportions and concentrations may be selected to give an electrical conductivity greater than a desired amount such as 50 picoSiemens/m.

Further Discussion

The composition of the present invention can be used in a Continuous Jet with Deflection printhead, but can also in general be used in any dispensing or printing apparatus which involves imparting electrostatic charge to drops, and it can even be used in a dispensing or spraying apparatus which involves imparting electrostatic charge to drops. The invention should be considered equally applicable to ordinary printing (such as onto paper), in addition to three-dimensional printing.

As discussed in some of the Examples, besides being used with halogenated hydrocarbon solvents, the present invention can also be used with hydrocarbon liquids. In addition to situations where it is desired to impart charge to a liquid, the present invention can also be used in situations in which it is desired to prevent buildup of static electricity, which could improve petroleum-handling safety. Hydrocarbon liquids and halogenated hydrocarbon solvents have traditionally been thought of as non-conductors, and it has been thought that non-conductivity was an inherent limitation of such liquids especially in the situations where the liquid had to be completely evaporable without leaving a solid residue.

The present invention can make halogenated hydrocarbon solvents and hydrocarbon liquids electrically conductive without even introducing any dissolved solid that could potentially deposit as a solid residue, and so this could remove a fundamental difficulty and make these liquids useful for applications not currently considered possible. In general herein, where no particular isomer of a chemical compound is specified, it should be understood that all possible isomers are being referred to.

All patents and applications cited above are incorporated by reference in their entirety. The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. Aspects of the invention can be modified, if necessary, to employ the process, apparatuses and concepts of the various patents and applications described above to provide yet further embodiments of the invention. These and other changes can be made to the invention in light of the above detailed description.

In general, in the following claims, the terms used should not be construed to limit the invention to the specific embodiments disclosed in the specification and the claims, but should be construed to include all compositions, methods, apparatus and articles that operate under the claims; Accordingly, the invention is not limited by the disclosure, but instead the scope of the invention is to be determined entirely by the following claims.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A composition, comprising a halogenated hydrocarbon solvent, and a co-solvent which is miscible with the halogenated hydrocarbon solvent, and a conductivity enhancing substance which is soluble in at least one of the halogenated hydrocarbon solvent and the co-solvent.

2. The composition of claim 1 wherein the conductivity enhancing substance is soluble in the co-solvent.

3. The composition of claim 2 wherein the conductivity enhancing substance is substantially insoluble in the halogenated hydrocarbon solvent.

4. The composition of claim 1 wherein the composition has an electrical conductivity at room temperature that is greater than 10 micro-Siemens/cm.

5. The composition of claim 1 wherein the halogenated hydrocarbon solvent and the co-solvent and the conductivity enhancing substance cooperate to produce a desired electrical conductivity.

6. The composition of claim 1 wherein the halogenated hydrocarbon solvent is chloroform.

7. The composition of claim 1 wherein the co-solvent has a dielectric constant greater than 20.

8. The composition of claim 1 wherein the co-solvent has a dielectric constant greater than 10.

9. The composition of claim 1 wherein the co-solvent is an alcohol.

10. The composition of claim 9 wherein the alcohol is methanol or ethanol.

11. The composition of claim 1 wherein the conductivity enhancing substance has at least one ionic bond.

12. The composition of claim 1 wherein the conductivity enhancing substance is a salt having an anion and a cation.

13. The composition of claim 12 wherein the anion is an organic radical.

14. The composition of claim 12 wherein the anion is a lipophilic radical.

15. The composition of claim 12 wherein the anion is selected from the group consisting of lactate, acetate, propionate, formate, salicylate, stearate, malate, laurate, oxalate, oleate, citrate, benzoate, succinate, myristate and tartarate.

16. The composition of claim 12 wherein the cation is a metal.

17. The composition of claim 12 wherein the cation is selected from the group consisting of sodium, potassium, calcium and magnesium.

18. The composition of claim 12 wherein the cation is an organic radical.

19. The composition of claim 12 wherein the cation is an ammonium radical.

20. The composition of claim 12 wherein the salt is selected from the group consisting of sodium L-lactate, potassium lactate, sodium stearate, sodium tetradecyl sulfate and sodium lauryl sulfate.

21. The composition of claim 12 wherein the salt is ammonium lactate.

22. The composition of claim 12 wherein the salt is ammonium acetate.

23. The composition of claim 1 wherein the conductivity enhancing substance is an acid.

24. The composition of claim 23 wherein the conductivity enhancing substance is an organic acid.

25. The composition of claim 23 wherein the acid is a liquid at room temperature.

26. The composition of claim 23 wherein the acid is acetic acid.

27. The composition of claim 1 wherein the conductivity enhancing substance is a polymer.

28. The composition of claim 27 wherein the polymer comprises side groups which can dissociate when the polymer is dissolved in a liquid.

29. The composition of claim 27 wherein the polymer is a methacrylate or poly lactic co-glycolic acid.

30. The composition of claim 27 wherein the conductivity enhancing substance is a polymeric acid.

31. The composition of claim 30 wherein the conductivity enhancing substance is poly acrylic acid, poly methacrylic acid, or poly lactic co-glycolic acid.

32. The composition of claim 27 wherein the polymer is a metallic salt of a polymeric acid.

33. The composition of claim 32 wherein the polymer is selected from the group consisting of a sodium salt of polyacrylic acid, a sodium salt of poly methacrylic acid, and carboxymethylcellulose sodium.

34. The composition of claim 1 wherein the conductivity enhancing substance is a solid at room temperature.

35. The composition of claim 1 wherein the conductivity enhancing substance is a solid at all temperatures up to a maximum allowable temperature of an article being manufactured.

36. The composition of claim 1 wherein the conductivity enhancing substance is a liquid at room temperature.

37. The composition of claim 1 wherein the conductivity enhancing substance has a boiling point which is lower than a maximum allowable temperature of an article being manufactured.

38. The composition of claim 1 wherein the conductivity enhancing substance has a sublimation temperature that is lower than a maximum allowable temperature of an article being manufactured.

39. The composition of claim 1 wherein the conductivity enhancing substance is capable of substantially evaporating at a temperature lower than a maximum allowable temperature of an article being manufactured.

40. The composition of claim 1 wherein the conductivity enhancing substance is capable of decomposing at a temperature lower than a maximum allowable temperature of an article being manufactured.

41. The composition of claim 1 wherein the conductivity enhancing substance is suitable to be dissolved by a supercritical fluid or a pressurized liquid.

42. The composition of claim 1 wherein the conductivity enhancing substance is suitable to be dissolved by a substance selected from the group consisting of: supercritical carbon dioxide, supercritical carbon dioxide with at least one additive, liquid carbon dioxide, and liquid carbon dioxide with at least one additive.

43. The composition of claim 1 wherein the conductivity enhancing substance is suitable to be dissolved by water or by alcohol or another organic solvent.

44. The composition of claim 1 wherein the conductivity enhancing substance comprises only at most carbon, oxygen, hydrogen and nitrogen.

45. The composition of claim 1 wherein the conductivity enhancing substance comprises only at most carbon, oxygen, hydrogen and nitrogen and an element selected from the group consisting of sodium, potassium, calcium and magnesium.

46. The composition of claim 1 wherein the conductivity enhancing substance is benign to the human body.

47. The composition of claim 1 wherein the halogenated hydrocarbon comprises at least approximately 70% by weight of the composition.

48. The composition of claim 1 wherein the co-solvent comprises between approximately 2% by weight and approximately 30% by weight of the composition.

49. The composition of claim 1, further comprising at least one additional substance dissolved in the composition.

50. The composition of claim 49 wherein the additional substance is a polymer.

51. The composition of claim 49 wherein the additional substance is an Active Pharmaceutical Ingredient.

52. A printhead comprising a source of droplets of a liquid, and a charging means for imparting charge to at least some droplets, and means for electrostatically deflecting the charged droplets, wherein the liquid includes a halogenated hydrocarbon solvent, a co-solvent that is miscible with the halogenated hydrocarbon solvent, and a conductivity enhancing substance that is soluble in at least one of the halogenated hydrocarbon solvent and the co-solvent.

53. The printhead of claim 52, further comprising a means for stimulating formation of the droplets.

54. The printhead of claim 52 wherein the source of droplets is a continuous jet.

55. The printhead of claim 52, comprising an electrical component in contact with the liquid upstream of the droplets.

56. The printhead of claim 52 wherein the charging means is such that it imparts to any individual droplet either essentially no charge or sufficient charge so that the droplet is deflected to a catcher.

57. The printhead of claim 52 wherein the charging means is such that it imparts to any individual droplet either essentially no charge, or sufficient charge so that the droplet is deflected to a catcher, or an intermediate amount of charge.

58. The printhead of claim 52, having dimensions and operating voltages and operating parameters suitable to cooperate with properties of the liquid to produce desired deflections of droplets.

59. A method of three dimensional printing an article, comprising dispensing through a printhead a liquid composition comprising a halogenated hydrocarbon solvent, a co-solvent that is miscible with the halogenated hydrocarbon solvent, and a conductivity enhancing substance that is soluble in at least one of the halogenated hydrocarbon solvent and the co-solvent.

60. The method of claim 59 wherein the printhead comprises means for imparting electric charge to droplets of the liquid.

61. The method of claim 59 wherein the printhead is a continuous jet with deflection printhead.

62. The method of claim 59 wherein the printhead produces droplets by means other than a continuous jet.

63. The method of claim 59, further comprising, after the dispensing, heating the article to a sufficient temperature for a sufficient time to promote evaporation of at least some of the liquid composition.

64. The method of claim 63 wherein the evaporation includes evaporation of the conductivity enhancing substance.

65. The method of claim 63 wherein the heating is performed after deposition of the liquid composition on an individual powder layer.

66. The method of claim 63 wherein the heating is performed after completion of three-dimensional printing.

67. The method of claim 59, further comprising, after the dispensing, heating the article to a sufficient temperature for a sufficient time to cause decomposition of at least some of the liquid composition.

68. The method of claim 67 wherein the decomposition includes decomposition of the conductivity enhancing substance.

69. The method of claim 59, further comprising exposing the article to a sub-ambient pressure for a time sufficient to promote evaporation of at least some of the liquid composition.

70. The method of claim 69 wherein the evaporation includes evaporation of the conductivity enhancing substance.

71. The method of claim 69, further comprising heating the article.

72. The method of claim 59, further comprising exposing the article to a flow of gas which is substantially free of the vapor of the liquid composition, for a time sufficient to promote evaporation of at least some of the liquid composition.

73. The method of claim 72 wherein the evaporation includes evaporation of the conductivity enhancing substance.

74. The method of claim 72, further comprising heating the article.

75. The method of claim 59, further comprising exposing the article to a supercritical fluid or a pressurized liquid of a substance that is gaseous at room temperature, under conditions suitable to remove at least one component of the liquid composition.

76. The method of claim 75 wherein the supercritical fluid or pressurized liquid is carbon dioxide.

77. The method of claim 75 wherein the supercritical fluid or pressurized liquid comprises carbon dioxide and an extraction co-solvent substance.

78. The method of claim 77 wherein the extraction co-solvent substance comprises methanol or acetone.

79. The method of claim 75 wherein the supercritical fluid or pressurized liquid comprises nitrous oxide or sulfur hexafluoride or a hydrocarbon or halogenated hydrocarbon having an atmospheric boiling point below room temperature.

80. The method of claim 59, further comprising exposing the article to water or an alcohol or another organic solvent.

81. An article manufactured by the method of claim 59.

82. The article of claim 81 wherein the article contains substantially no halogenated hydrocarbon solvent or co-solvent or conductivity enhancing substance.
